(19) United States
(12) Patent Application Publication
(10) Pub. No.: US 2004/0170116 A1
(43) Pub. Date: Sep. 2, 2004

(54) Optical disc incorporating a relief pattern

(75) Inventors: Imtiaz Moloo, Calgary (CA); Munirun Boga, Calgary (CA)

Correspondence Address: GRAY CARY WARE & FREIDENRICH LLP, 4365 EXECUTIVE DRIVE, SUITE 1100, SAN DIEGO, CA, 92121-2133, US

(73) Assignee: E3 Works International Inc., Warrens (BB)

(21) Appl. No.: 10/754,686

(22) Filed: Jan. 8, 2004

Related U.S. Application Data
(60) Provisional application No. 60/438,506, filed on Jan. 8, 2003.

(51) Int. Cl. G11B 7/24

(52) U.S. Cl. 369/275.4

(57) ABSTRACT

The present invention provides an optical disc for storing information, wherein the optical disc comprises a microscopic relief pattern on one side thereof, providing a structure for storing information in a digital format. The opposite side of the optical disc comprises a macroscopic relief pattern that can provide a means of protection for the optical disc.

### CROSS REFERENCE TO RELATED APPLICATION(S)

This application claims the benefit of priority under 35 U.S.C. § 119(e) of U.S. Serial No. 60/438,506, filed Jan. 8, 2003, the entire content of which is incorporated herein by reference.

### BACKGROUND OF THE INVENTION

### FIELD OF THE INVENTION

The present invention pertains to the field of optical discs, and in particular to an optical disc incorporating a relief pattern.

### BACKGROUND INFORMATION

Optical discs have been in use since the early 1980s and have largely replaced vinyl phonograph records as a major medium for recording and playing back of audio information. Optical discs currently come in multiple different forms. Compact discs (CDs) are commonly used to record music. CD-ROMs are commonly used to record data for use by personal computers. Digital versatile discs (DVDs), which have an even larger capacity to store data than CDs and CD-ROMs, are commonly used to record video as well as large amounts of digital data for other purposes. There are other types of optical discs including: CD-Rs on which a user can write, but not re-write, information; and CD-RWs on which users can both write and re-write data. It is probable that there will be new types of optical discs in the future from which recorded information can be read by light.

Optical discs have many benefits. They are much smaller than many other products capable of storing an equal amount of data. Often their data can be read with virtually perfect accuracy despite the presence of dust. This is due, in part, to their recording of redundant information to help them correct minor reading errors. And since they are read optically, the process of reading them does not wear out their data recording surfaces. Unfortunately, however, scratches on the surface of an optical disc can reduce the ability of the laser circuitry that reads such discs to track or read data on the disc, making all or a portion of such an optical disc unreadable.

An optical disc is comprised of two sides. Both are important in the laser circuitry's ability to read information encoded on the disc.

The read, or data, side is read by the laser circuitry directly by focusing a light beam on a very small point on the disc and “reading” small pits or impressions which represent the 1's and 0's that make-up the data stream that encodes audio, video, or data information. Any substantial scratch in the clear coating on the read side of the disc can undesirably block or deflect light, causing the laser circuitry to misread data or become confused as to where it is in the context of the binary data stream. This can cause the player to play the same block of data repeatedly, which, in the case of an audio CD, produces a sound similar to the “skipping” which commonly occurred in the playback of scratched vinyl records. In some cases such scratches can force the playback of the optical disc to stop entirely.

The second side of an optical disc, the “label” side, does not typically record laser-readable information, but it does serve an important role in the playback of such information. In addition to providing a surface upon which a label for the disc can be written or printed, the label side has a thin reflective layer needed to provide a relatively even reflective background to the layers of the disc's read side on which information is recorded. This relatively even backdrop for the data side allows the laser circuitry to more easily discern between 1 and 0 bits.

A scratch on the label side deep enough to tear into its reflective layer can render a disc unreadable. This condition may be observed by holding the optical disc up to a light source and viewing the holes in the reflective layer allowing light to pass through.

In addition, when optical discs are stacked one on top of another, the subsequent separation of these optical discs may be difficult due to the attraction resulting from the relatively smooth nature of the contacting faces of the optical discs. The stacking one on top of another is common, having regard to recordable or rewritable optical discs, especially when one considers that these types of optical discs are packaged and sold in large quantities, for example, 50 or 100 discs. Hence, one may slide one disc across the face of the second in order to separate them, or use for example a finger nail to separate the two discs. However, either of these actions may result in the scratching of the first and/or second side of the disc, potentially damaging the ability of an optical reader to detect or read the information stored thereon.

Hence there is a need for an improved optical disc which provides for the ease of separation of stacked optical discs in addition to added protection to the “label” side thereof.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an optical disc incorporating a relief pattern. In accordance with an aspect of the present invention, there is provided an optical disc for storing information, said optical disc comprising: a substrate having a first side surface and a second side surface; a microscopic relief pattern formed on the first side surface of the substrate, said microscopic relief pattern providing a structure for storing information in a digital format; and a macroscopic relief pattern formed on the second side surface of the substrate, said macroscopic relief pattern providing a protective barrier.

### BRIEF DESCRIPTION OF THE DRAWINGS

FIG. 1 is a plan view of the macroscopic relief pattern of the optical disc according to one embodiment of the present invention.

FIG. 2 is a cross sectional view of the a portion of the optical disc according to one embodiment of the present invention, wherein the relief pattern is a series of flat peaks and valleys.

FIG. 3 is a cross sectional view of a portion of the optical disc according to one embodiment of the invention, wherein the relief pattern is a series of sharp peaks and valleys.

FIG. 4 is a plan view of the opposite side of the optical disc according to one embodiment of the present invention.

### DETAILED DESCRIPTION OF THE INVENTION

The present invention provides an optical disc for storing information, wherein the optical disc comprises a microscopic relief pattern on one side thereof, providing a structure for storing information in a digital format. The opposite side of the optical disc comprises a macroscopic relief pattern that can provide a means of protection for the optical disc. In addition, this macroscopic relief pattern may provide a means for easier separation of optical discs that are stacked one on top of another, thereby potentially providing a form of protection to inadvertent scratching of the optical disc during separation thereof.

Microscopic Relief Pattern

The first side of the optical disc comprises a microscopic relief pattern that is the same as that which is commonly provided in optical discs for the storage of information, as would be known to a worker skilled in the art. The microscopic relief pattern is provided on the substrate, which is typically a polycarbonate substrate, and comprises millions of small indentations that are provided in a spiral track formation from the inside to the outside of the optical disc. Each of the small indentations provides a means for the storage of digital information that can be “read” by a properly aligned light beam having a predetermined wavelength. As would be known to a worker skilled in the art, the optical disc can be fabricated in a variety of formats, for example, a read only format, recordable format or a rewritable format. In the recordable and rewritable formats of optical discs, an additional layer of material is provided in order to enable this ability, as would be known to a worker skilled in the art.

Macroscopic Relief Pattern

The second side of the optical disc comprises a macroscopic relief pattern that can provide a protective barrier for the optical disc, potentially protecting the reflective metallic layer associated with the optical disc. The macroscopic relief pattern can cover a portion or all of the second side of the optical disc.

For example, a first protective feature of the macroscopic relief pattern is realised by the mechanical or physical barrier that this pattern provides, wherein this relief pattern can reduce the possibility of scratching the second side of the optical disc. A second protective feature of the relief pattern can be a result of the reduction in the contact area between optical discs that may be stacked one on top of another. By the reduction of the contact area therebetween, there may be a reduction in the attraction between the stacked optical discs thereby potentially providing a means for easier separation thereof. A potentially improved ability of separation of the optical disc may decrease the necessity of sliding discs across the faces of each other in order to separate them, potentially reducing the probability of scratching these surfaces.

The macroscopic relief pattern on the second side of the optical disc can take a variety of patterns and shapes and may additionally be aesthetically pleasing, for example. The relief pattern can be fabricated to represent any variety of shapes, letters, symbols or any combination thereof. Optionally, the relief pattern can be in the form of a picture, for example. Due to the high rotational speed of the optical disc during use, it is important to note that the macroscopic relief pattern should not be overly asymmetric since this may result in an instability of the optical disc during its rotation, due to asymmetry of the mass of the disc with respect to its centre of rotation. An excessive asymmetry of the macroscopic relief pattern may therefore result in errors occurring during the reading and potentially writing on the microscopic relief pattern associated with the first side of the optical disc. A worker skilled in the art would understand what level of asymmetry is allowable in order to ensure sufficient stability of the optical disc during its rotation.

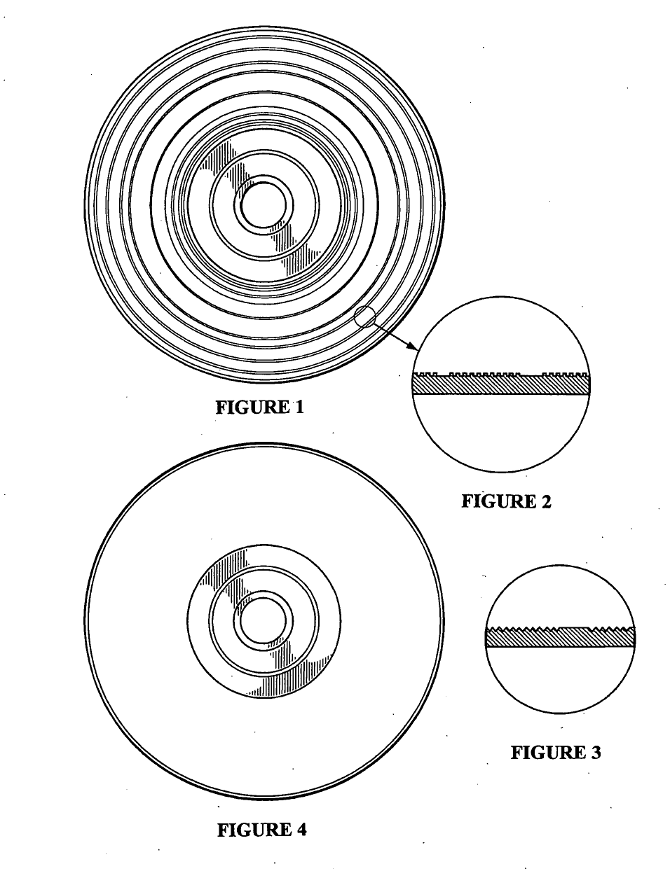

In one embodiment of the invention, the macroscopic relief pattern can take the shape of a plurality of concentric rings centred about the centre of the optical disc, as illustrated in FIG. 1. In an alternate example, the relief pattern can be in the form of one or more spirals also centred about the centre of the optical disc. In these examples, this form of the relief pattern can emulate that which would typically be visible on a vinyl record, for example. In addition to either of these forms of relief patterns, there may additionally be a label area associated with the central region of the second side of the optical disc. This label region may be similar to that associated with a vinyl record, for example. This printed area may be associated with the optical disc by the adhesion of a substrate carrying the desired graphics or the printed area may be printed directly on the optical disc using a variety of coloured dyes, for example.

The macroscopic relief pattern is formed from a plurality of peaks and valleys which define the desired shape of the pattern on the second side of the optical disc. In one embodiment of the invention, the peaks and valleys can have flat transitions therebetween, as illustrated in FIG. 2. These transitions between the peaks and valleys can also be sharp in nature as illustrated in FIG. 3. Optionally, the transitions between the valleys and peaks may be more rounded in nature.

The macroscopic relief pattern can be associated with the optical disc using a number of different techniques. For example, this relief pattern can be moulded into the optical disc during the casting process thereof, etched into the optical disc after its fabrication, or a label having the desired relief pattern thereon can be adhered to the optical disc after manufacture.

In one embodiment, if the macroscopic relief pattern is etched onto the optical disc, the disc may be manufactured such that it is slightly thicker than a standard optical disc thereby providing additional material for the etching thereof after manufacture. For example, this additional thickness may protect the reflective metallic layer associated with the optical disc, from being damaged during the etching process.

In one embodiment of the invention, a label is adhered to the optical disc, wherein this label comprises the macroscopic relief pattern thereon. The relief pattern can be created on the label by means of etching, embossing, stamping or any other technique that enables the fabrication of a macroscopic relief pattern on the label. The label can be fabricated from any number of materials for example, paper, plastic, vinyl or any other type of material that may be associated with an optical disc, as would be known to a worker skilled in the art.

In one embodiment of the present invention, the second side of the optical disc comprises a label in addition to a macroscopic relief pattern. This label can be either adhered to the optical disc or may optionally be printed directly thereon. In one embodiment the label is adhered to the optical disc. In this embodiment, the label can be manufactured from a variety of materials including paper, vinyl, plastic or any other type of material as would be known to a worker skilled in the art which enables printing thereon and would be compatible for use with an optical disc.

In one embodiment, the macroscopic relief pattern may provide a means for advertising by designing the relief pattern such that it presents a specific advertisement for a product or the relief pattern represents a company logo, for example. In this manner, one may be able to provide specifically directed optical discs to the public. In one embodiment, the relief pattern can be formed such that the optical disc looks like a vinyl record on one side, thereby potentially drawing upon nostalgia associated with this older form of music recording, for example.

In one embodiment of the invention, the macroscopic relief pattern is designed such that it is an analog recording of information, for example a song as is known having regard to a vinyl record. This form of relief pattern comprises a main spiral format and a plurality of indentations which enable a cartridge or needle of a record player or phonograph to detect the information stored thereon. In one embodiment, as is common with a vinyl record, for example a single LP or 45, a mounting can be placed within the central portion of the optical disc which reduces the hole diameter to one compatible with a record player, thereby enabling one to play the analog information imprinted on the second side of the optical disc. In this embodiment, a layer that is resistance to the abrasion of the cartridge or needle can be integrated into the optical disc between the reflective metallic layer and the macroscopic relief pattern for added protection against scratches.

In one embodiment of the invention, the macroscopic relief pattern associated with an optical disc can be designed as a security feature. For example, the macroscopic relief pattern may be scanned by an optical disc player prior to scanning of the digital information on the opposite side thereof. In this manner, if a particular security feature associated with the macroscopic relief pattern is not detected, the optical disc player may not read the information on the opposite side thereof. In this manner one may be able to counteract unauthorised copying of optical discs by incorporating a physical security feature.

Presently, there are a number of optical disc players that enable on to view an optical disc during its rotation. In one embodiment of the invention, the macroscopic relief pattern can be designed such that upon rotation of the optical disc one or more illusions or other images become visible. A worker skilled in the art would understand how design a macroscopic relief pattern such that the desire affect is realised.

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical disc for storing information, said optical disc comprising:
a) a substrate having a first side surface and a second side surface;
b) a microscopic relief pattern formed on the first side surface of the substrate, said microscopic relief pattern providing a structure for storing information in a digital format; and
c) a macroscopic relief pattern formed on the second side surface of the substrate, said macroscopic relief pattern providing a protective barrier.

2. The optical disc according to claim 1, wherein the optical disc has a centre and wherein the macroscopic relief pattern is a plurality of concentric rings approximately centred with respect to the centre of the disc.

3. The optical disc according to claim 1, wherein the optical disc has a centre and wherein the macroscopic relief pattern is a one or more spirals approximately centred with respect to the centre of the optical disc.

4. The optical disc according to claim 1, wherein the macroscopic relief pattern is formed from a plurality of peaks and valleys.

5. The optical disc according to claim 4, wherein a transition between a peak and an adjacent valley, is sharp.

6. The optical disc according to claim 4, wherein a transition between a peak and an adjacent valley, is flat.

7. The optical disc according to claim 4, wherein a transition between a peak and an adjacent valley, is rounded.
